(19) United States
(12) Patent Application Publication
(10) Pub. No.: US 2013/0232063 A1
(43) Pub. Date: Sep. 5, 2013

(54) Methods and Systems for Generating Enhanced Business Cards

(71) Applicant: MASTERCARD INTERNATIONAL INCORPORATED, Purchase, NY (US)

(72) Inventor: David Paul Butler, Celebration, FL (US)

(73) Assignee: MasterCard International Incorporated, Purchase, NY (US)

(21) Appl. No.: 13/781,102

(22) Filed: Feb. 28, 2013

Related U.S. Application Data
(60) Provisional application No. 61/605,966, filed on Mar. 2, 2012.

(51) Int. Cl. G06Q 20/34

(52) U.S. Cl. CPC G06Q 20/355
USPC 705/41

(57) ABSTRACT

A computer system and method for processing an enhanced business card is provided, wherein the enhanced business card has a value stored thereon. The computer system includes a memory device for storing data and a computer system associated with a service provider (SP) that includes a processor. The SP computer system is configured to communicate with the memory device and is programmed to receive identifying data identifying a recipient of the enhanced business card, provide the identifying data, including identifying data for the recipient, to an issuer of the enhanced business card, and load a value provided by the SP on the enhanced business card. The SP computer system may load additional value provided by the SP when the recipient of the enhanced business card performs an action predetermined by the SP.

### CROSS REFERENCE TO RELATED APPLICATIONS

This application claims the benefit of U.S. Provisional Application No. 61/605,966, filed Mar. 2, 2012, which is hereby incorporated by reference in its entirety.

### BACKGROUND OF THE INVENTION

This invention relates generally to generating enhanced business cards and, more particularly, to a network-based system and method for generating an enhanced business card having contact information stored thereon, and providing the enhanced business card to a selected user, wherein the enhanced business card is a pre-paid transaction card having a value stored thereon.

Typical business cards are used to exchange contact details such as business information about a company and/or an individual. Business cards are usually shared during introductions or following conversations as a convenience and a memory aid to the person receiving it. However, over time, or after attending numerous business events such as conventions and tradeshows, a person may accumulate a large amount of business cards and merely lose or discard them because the business cards fail to capture the interest of the person receiving the business cards. This results in a failure of business card owners to expand their businesses and increase productivity.

Accordingly, it is desirable to enhance a traditional business card by providing it with a value such that the recipient of the card is more likely to keep it and further inquire about the products and services associated with the company.

### BRIEF DESCRIPTION OF THE INVENTION

In one embodiment, a computer system for processing an enhanced business card is provided. The computer system is associated with a service provider (SP), and includes a memory device for storing data, and a processor. The processor is in communication with the memory device and is programmed to receive identifying data identifying a recipient of the enhanced business card. The processor is further programmed to provide the received identifying data to an issuer of the enhanced business card. The processor is further programmed to load a value provided by the SP on the enhanced business card.

In another embodiment, a computer-implemented method of processing an enhanced business card, using a computing device coupled to a memory device, is provided. The method includes receiving, at the computing device, identifying data identifying a recipient of the enhanced business card. The method further includes providing the received identifying data to an issuer of the enhanced business card. The method further includes using the computer device to load a value provided by a service provider (SP) on the enhanced business card.

In another embodiment, one or more computer-readable storage media having computer-executable instructions embodied thereon for processing an enhanced business card are provided. The computing device includes a memory device and a processor associated with a service provider (SP). When executed by said processor, the computer-executable instructions cause the processor to receive identifying data identifying a recipient of the enhanced business card. The computer-executable instructions further cause the processor to provide the received identifying data to an issuer of the enhanced business card. The computer-executable instructions further cause the processor to load a value provided by the SP on the enhanced business card.

### BRIEF DESCRIPTION OF THE DRAWINGS

FIG. 1 is a simplified block diagram of an exemplary service provider (SP) processing system including a plurality of computer devices in accordance with one embodiment of the present invention.

FIG. 2 is an expanded block diagram of an exemplary embodiment of a server architecture of an SP processing system including other computer devices in accordance with one embodiment of the present invention.

FIG. 3 is a block diagram of an exemplary embodiment of a user computer device as shown in FIGS. 1 and 2.

FIG. 4 is a block diagram of an exemplary embodiment of a server computer device as shown in FIGS. 1 and 2.

FIG. 5 is a detailed block diagram of an exemplary configuration of the SP processing system in communication with other computer devices as shown in FIGS. 1 and 2.

FIG. 6 is a data flow diagram showing the communication of information between the SP computer system, the developer computer device, the merchant computer device, and the user computer device as seen in FIG. 5 and applied to the exemplary embodiment.

FIG. 7 is a screenshot of the startup screen for a service application implemented on a smartphone as described in FIGS. 5 and 6.

FIG. 8 is a screenshot of available funding sources for a service application implemented on a smartphone as described in FIGS. 5 and 6.

FIG. 9 is a screenshot of a send funds function for a service application implemented on a smartphone as described in FIGS. 5 and 6.

FIG. 10 is a screenshot of a request funds for a service application implemented on a smartphone as described in FIGS. 5 and 6.

FIG. 11 is a screenshot of a user home screen for a service application implemented on a smartphone as described in FIGS. 5 and 6.

FIG. 12 is a data flow diagram that shows the data transfers relating to a P2P service application and an API platform as shown in FIG. 5.

FIG. 13 is a block diagram that illustrates the transfer of funds from an SP funding source account to a recipient receiving account as shown in FIG. 12.

FIG. 14 is a simplified illustration of an example transaction card for use in association with the systems and methods described herein.

### DETAILED DESCRIPTION OF THE INVENTION

Embodiments of the present invention described herein relate to generating an enhanced business card having contact information stored thereon, and providing the enhanced business card to a targeted user, wherein the enhanced business card is a pre-paid transaction card having a value stored thereon, or associated with the card. The enhanced business card is generated using a Service Provider (SP) computer system, such as a payment card processing computer system, that enables the SP to receive identifying data identifying a recipient of the enhanced business card, provide the identifying data identifying the recipient to the bank issuing the enhanced business card, and load or associate a value on the enhanced business card. The SP computer system also enables the recipient of the enhanced business card to add further value to the card if the recipient accesses a service provided by the SP.

In the example embodiment, an enhanced business card is a reloadable, pre-paid transaction card that is branded with contact information associated with the giver of the card (i.e., SP information). For example, the enhanced business card may be given by a SP representative to a recipient (a desired or selected user). While the recipient is present, the representative uses a software application to input details required by issuing banks to personalize the card to the recipient, which may include name, address, home, work, and cell phone numbers, and/or email address. The software application may store the recipient's contact details for later use by the SP in a sales management or other database. Once the card has been personalized, the representative also uses the software application to transfer money or other value (complimentary coffee, or other beverage, etc.) to the pre-paid card, thus providing the recipient with a fully functional pre-paid transaction card that has a value assigned thereto. Moreover, the card may advertise further services offered by the SP. For example, the enhanced card may include a uniform resource locator (URL) to a portal website where the recipient could sign-up or register for the SP's services or products. This may trigger a second transfer of value to the enhanced business card by the SP.

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an exemplary embodiment, namely, systems and methods of generating an enhanced business card having certain contact information stored thereon, and providing the enhanced business card to a targeted user, wherein the enhanced business card is a pre-paid transaction card having a value stored thereon. However, it is contemplated that this disclosure has general application to computing systems in industrial, commercial, and residential applications.

The methods and systems described herein may be implemented using computer programming or engineering techniques including computer software, firmware, hardware or any combination or subset thereof, wherein the technical effect may be achieved by performing at least one of the following steps: (a) receive identifying data identifying a recipient of the enhanced business card; (b) provide the received identifying data to an issuer of the enhanced business card; (c) load a value provided by the SP on the enhanced business card; (d) load additional value provided by the SP when the recipient of the enhanced business card performs an action predetermined by the SP; (e) store recipient identifying data in a database associated with the SP; (f) receive recipient registration information; (g) compare the received recipient registration information to the stored recipient identifying data; (h) confirm the identity of the recipient; (i) receive from the issuer a confirmation of receipt of recipient identifying data by the issuer; and (j) initiate a monetary transfer using a P2P application.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

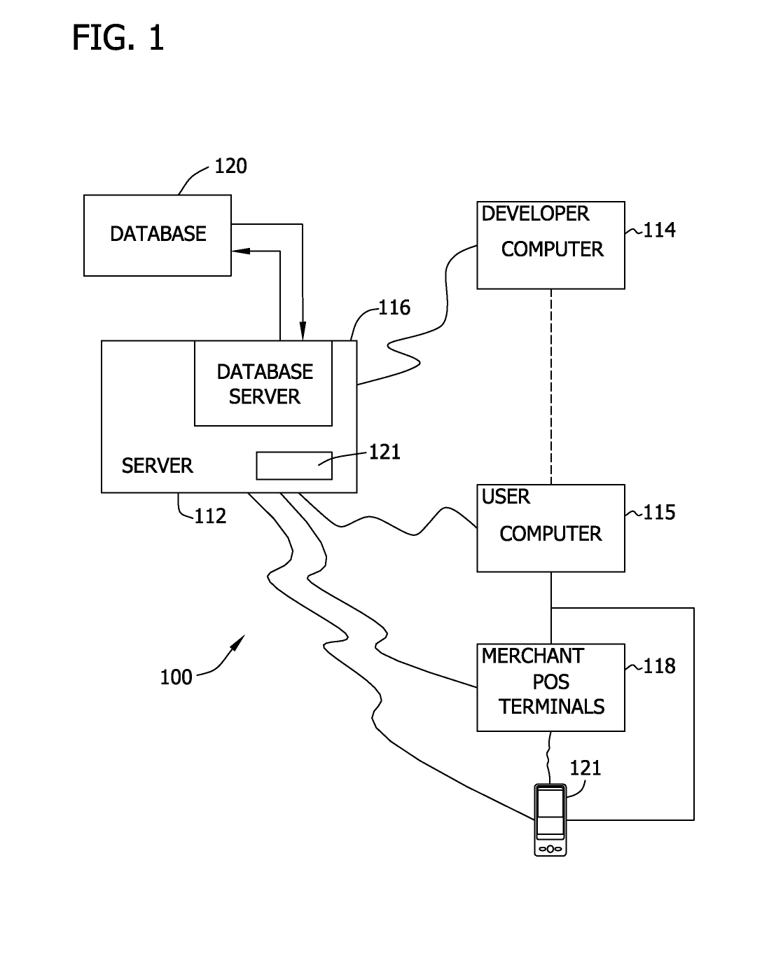

FIG. 1 is a simplified block diagram of an exemplary service provider (SP) processing system 100 including a plurality of computer devices in accordance with one embodiment of the present invention. In addition, in the example embodiment, system 100 is a transaction card processing system that is configured to process payment transactions and transfer value (i.e., monetary funds or other value) to a transaction card such as an enhanced business card described herein. System 100 includes an SP computer system (e.g., financial services provider or a non-financial services provider) that allows developers of computer applications to access a variety of service applications hosted by SP computer system such that the developer applications can utilize data stored within the SP computer system. The developer applications can be utilized by the developer via a developer computer device or can be offered to a consumer, a merchant, an acquirer or an issuer (collectively a “user”) for use by the users via user computer devices. After enrolling a developer with the SP computer system or accessing a service application provided by the SP, system 100 is configured to transfer additional value to an enhanced business card.

More specifically, in the example embodiment, system 100 includes a server system 112, which is a type of computer system, and a plurality of client sub-systems (also referred to as client systems 114 and 115) connected to server system 112. In one embodiment, client systems 114, 115 are computers including a web browser, such that server system 112 is accessible to client systems 114, 115 using the Internet. Client systems 114, 115 are interconnected to the Internet through many interfaces including a network, such as a local area network (LAN) or a wide area network (WAN), dial-in-connections, cable modems, and special high-speed ISDN lines. Client systems 114, 115 could be any device capable of interconnecting to the Internet including a web-based phone, personal digital assistant (PDA), or other web-based connectable equipment.

System 100 also includes point-of-sale (POS) terminals 118, which may be connected to client systems 114, 115. POS terminals 118 may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114, 115 by logging onto server system 112 through one of client systems 114, 115. In an alternative embodiment, database 120 is stored remotely from server system 112 and may be non-centralized.

Database 120 may store transaction data generated as part of sales activities conducted over the services network including data relating to merchants, account holders or customers, developers, issuers, acquirers, purchases made, and services provided by system 100. Database 120 may also store account data including at least one of a cardholder name, a cardholder address, an account number, and/or other account identifiers. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, client system 114 may be associated with a developer of computer applications and may be referred to as a developer computer device 114, and client system 115 may be associated with a consumer, an acquirer or an issuer and may be referred to as a user computer device 115. Developer computer device 114 stores developer applications that a user may access and utilize via user computer device 115. Server system 112 may be associated with an SP and may be referred to as a SP computer system 112. In the example embodiment, an SP may include a payment network provider, an interchange network provider, or any other provider of financial or non-financial services.

System 100 also includes portable computing device 121. Device 121 can be a smartphone, mobile phone, personal digital assistants (PDAs), iPhone® (iPhone is a registered trademark of Apple, Incorporated located in Cupertino, Calif.), Android® (Android is a registered trademark of Google Incorporated, located in Mountain View, Calif.), and/or any device capable of executing stored computer-readable instructions. Device 121 can be associated with the SP or with another user utilizing system 100. Device 121 is configured to access service applications offered by the SP and communicate with other devices within system 100 such as devices 114, 115, and 118.

Although the SP has been described herein as an interchange network provider, it does not have to be so limited. As indicated above, the SP may also be a payment network provider or any other provider of financial services. In these embodiments, a transaction card, a payment or even a purchase are not necessarily needed to utilize the services provided by the SP. In another embodiment, the SP may include any provider of financial or non-financial services and the developer may include a consumer in any business to whom the SP wishes to market a product.

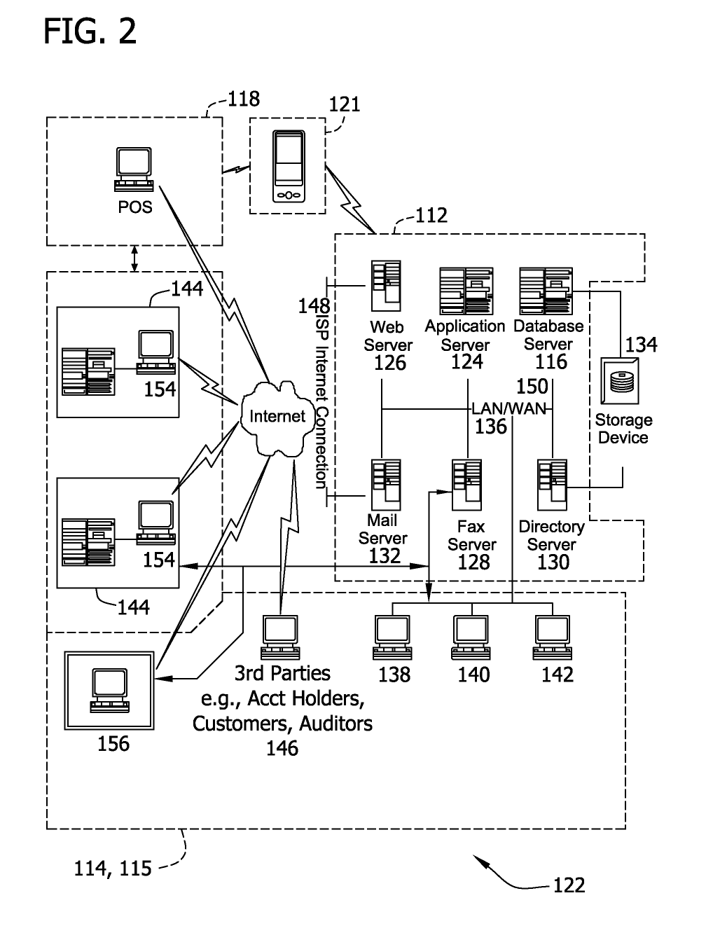

FIG. 2 is an expanded block diagram of an exemplary embodiment of a server architecture of an SP processing system 122 including other computer devices in accordance with one embodiment of the present invention. Components in system 122, identical to components of system 100 (shown in FIG. 1), are identified in FIG. 2 using the same reference numerals as used in FIG. 1. System 122 includes server system 112, client systems 114 and 115, POS terminals 118 and portable computing device 121. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

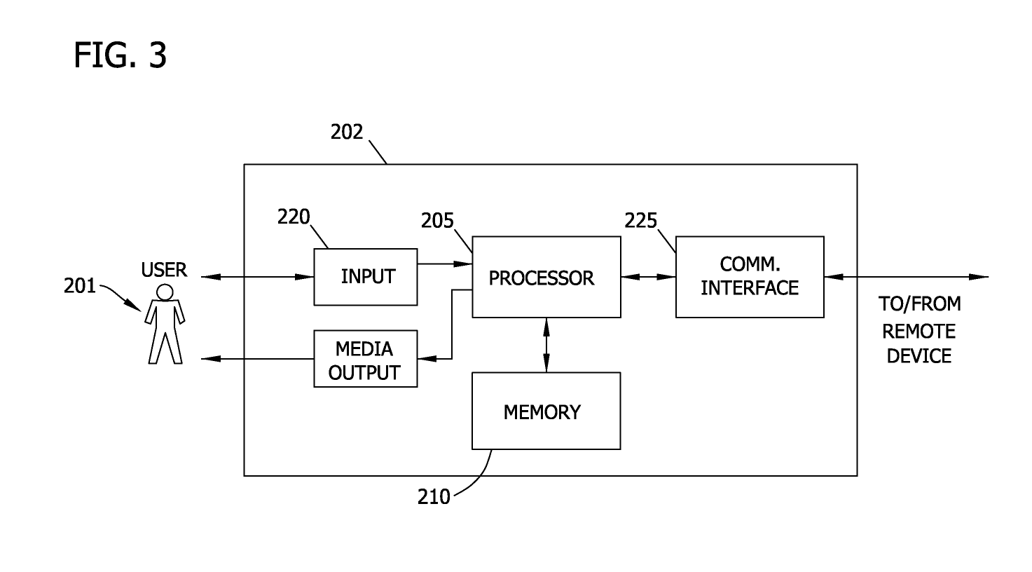

FIG. 3 illustrates an exemplary configuration of a user computer device 202 operated by a user 201. User computer device 202 may include, but is not limited to, client systems 114, 115, 121, 138, 140, and 142, 146, POS terminal 118, workstation 154, and manager workstation 156 (shown in FIG. 2).

User computer device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer readable media.

User computer device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, user computer device 202 includes an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

User computer device 202 may also include a communication interface 225, which is communicatively coupleable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

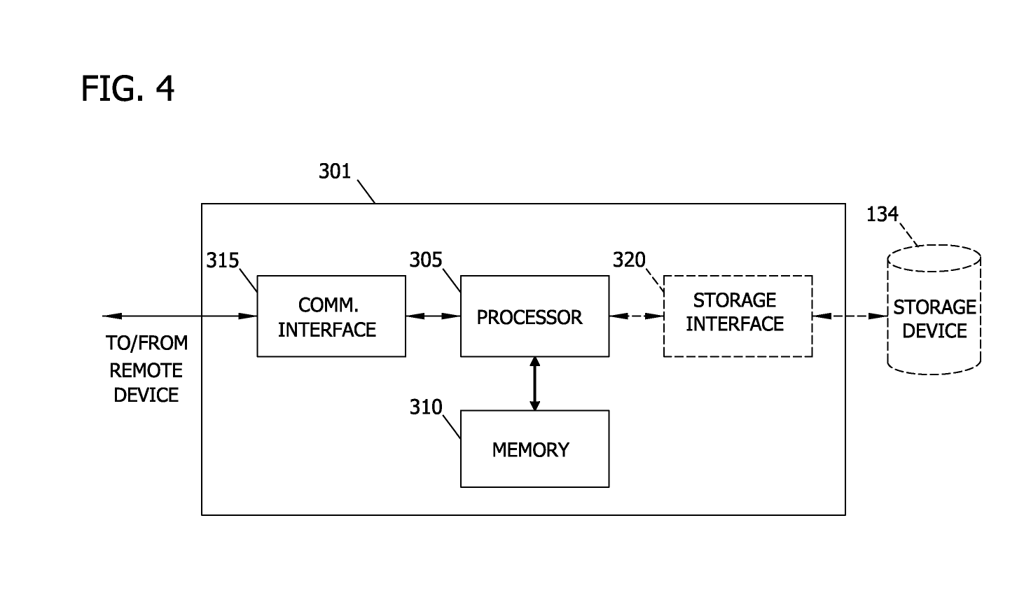

FIG. 4 illustrates an exemplary configuration of an SP computer device 301 such as server system 112 (shown in FIGS. 1 and 2). SP computer device 301 may include, but is not limited to, database server 116, transaction server 124, web server 126, fax server 128, directory server 130, and mail server 132.

SP computer device 301 includes a processor 305 for executing instructions. Instructions may be stored in a memory area 310, for example. Processor 305 may include one or more processing units (e.g., in a multi-core configuration).

Processor 305 is operatively coupled to a communication interface 315 such that SP computer device 301 is capable of communicating with a remote device such as user computer device 202 or another SP computer device 301. For example, communication interface 315 may receive requests from user computer device 114, 115 via the Internet, as illustrated in FIGS. 1 and 2.

Processor 305 may also be operatively coupled to a storage device 134. Storage device 134 is any computer-operated hardware suitable for storing and/or retrieving data. In some embodiments, storage device 134 is integrated in SP computer device 301. For example, SP computer device 301 may include one or more hard disk drives as storage device 134. In other embodiments, storage device 134 is external to SP computer device 301 and may be accessed by a plurality of SP computer devices 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory areas 210 and 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

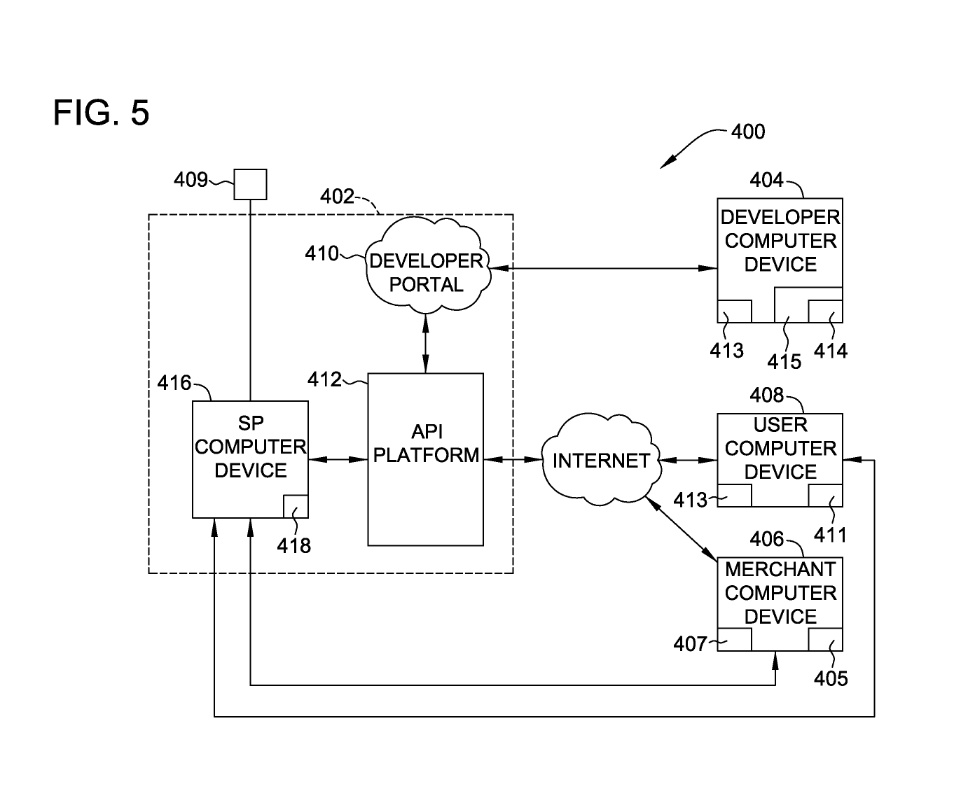

FIG. 5 illustrates an exemplary configuration of an exemplary SP processing system 400 in accordance with the present invention. In the example embodiment, system 400 includes an SP computer system 402 similar to SP server system 112 (shown in FIGS. 1 and 2), a developer computer device 404 similar to developer computer device 114 (shown in FIGS. 1 and 2), a merchant computer device 406 similar to user computer device 115 or POS terminals 118 (shown in FIGS. 1 and 2), a user computer device 408 similar to user computer device 115 (shown in FIGS. 1 and 2), and a portable computing device 409 similar to portable computing device 121 (shown in FIGS. 1 and 2). SP processing system 400 also includes a developer portal 410 and an API platform 412 for facilitating communication between computer devices 402, 404, 406, 408, and 409. SP computer system 402 also includes an SP computer device 416.

Developer computer device 404 includes a processor 413 for executing instructions. Instructions may be stored in a memory area 415. The memory area may also include one or more developer applications 414. Applications 414 include computer-implemented instructions that cause a computer device to interact with another computer device. Developer computer device 404 is in communication with SP computer system 402 through developer portal 410.

Developer portal 410 is configured to communicate with developer computer device 404, and facilitates managing developer registration and login with SP computer system 402. Developer portal 410 also enables developer computer device 404 to communicate with API platform 412 by sending, for example, a data request to SP computer device 416 that is directed to a service application 418 stored on SP computer device 416.

Merchant computer device 406 includes a processor 407 for executing instructions that may be stored in a memory area 405. Similarly, user computer device 408 includes a processor 413 for executing instructions that may be stored in a memory area 411. The memory areas 405, 411 may also include one or more developer applications 414 downloaded from developer computer device 404 for use by the merchant, consumer, acquirer, and/or issuer (collectively a “user”). In other words, a developer may develop an application that can be used by a user on their computer devices (e.g., a POS device, a personal computer, smart phone or PDA). The user downloads the application from the developer to their computer device for use by the user. When the user uses developer application 414, merchant and/or user computer devices 406, 408 communicate through the Internet with SP computer system 402 through API platform 412. Moreover, in the case that merchant computer device 406 is using POS terminals 118, merchant computer device 406 is wirelessly connected directly to SP computer device 416 for processing transactions.

A developer is able to engage a customer of the SP. The developer can build applications 414 for any of SP's business partners, including merchants, issuers, acquirers, or any other party in the SP network. The following examples describe a developer building a developer application 414 for a merchant user (the user could also be an individual, an acquirer, a processor or an issuer). The developer may be working directly for a merchant or for themselves to sell their application 414 to a merchant. The roles of the developer and merchant are separate. The SP does not have to be part of the relationship between the developer and the merchant.

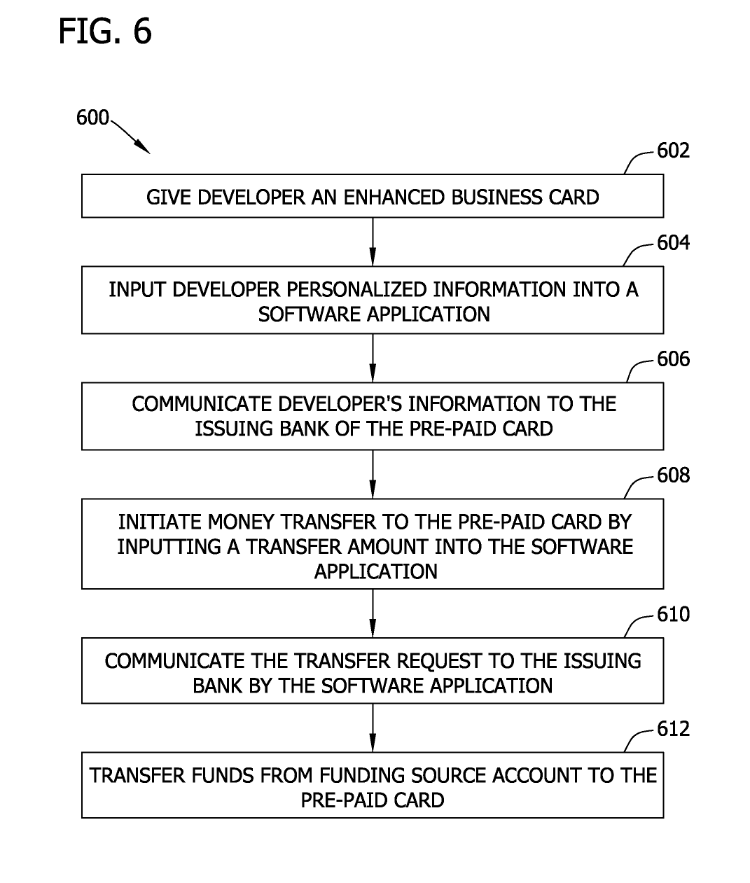

FIG. 6 is a data flow diagram 600 showing the communication of information between SP computer system 402, developer computer device 404, merchant computer device 406, user computer device 408, and portable computing device 409 as seen in FIG. 5 and applied to the enhanced business card described herein. By way of example, an SP representative attending a software application convention or tradeshow uses the enhanced business card to demonstrate certain services offered by the SP through SP processing system 400. For example, an SP representative may want to demonstrate a person-to-person (P2P) MoneySend™ (MoneySend™ is a trademark of MasterCard International Incorporated located in Purchase, N.Y.) service application or some other service application offered by the SP through API platform 412 of system 400. The SP representative gives 602 a developer an enhanced business card that contains the SP representative's contact information or other information identifying the SP or a service provided by the SP, as well as pre-paid card data. The SP representative then inputs 604 the developer's personalized information as required by most issuing banks into a software application such as service application 418 (shown in FIG. 5) stored in SP computer device 416 (shown in FIG. 5). In one embodiment, the SP representative may use portable computing device 409 (i.e., a smartphone) to access service application 418 stored on SP computer device 416. The inputted information may include the developer's name, address, home, work, and cell phone numbers, and/or email address. When the SP representative finishes inputting the developer information, service application 418 communicates 606 the developer information to user computer device 408, which in this case is an issuing bank's device. When the issuing bank confirms receipt of the information to the SP representative, e.g., via portable computing device 409, the SP representative then initiates 608 a money transfer (i.e., activates the P2P MoneySend™ application) to the enhanced business card by inputting a transfer amount for the specific enhanced business card into service application 418. Service application 418 communicates 610 the transfer request to the issuing bank's device. The issuing bank's device then transfers 612 the funds or other value from a funding source account to the enhanced business card, or to a receiving account. The developer is then left with a personalized enhanced business card with value stored thereon.

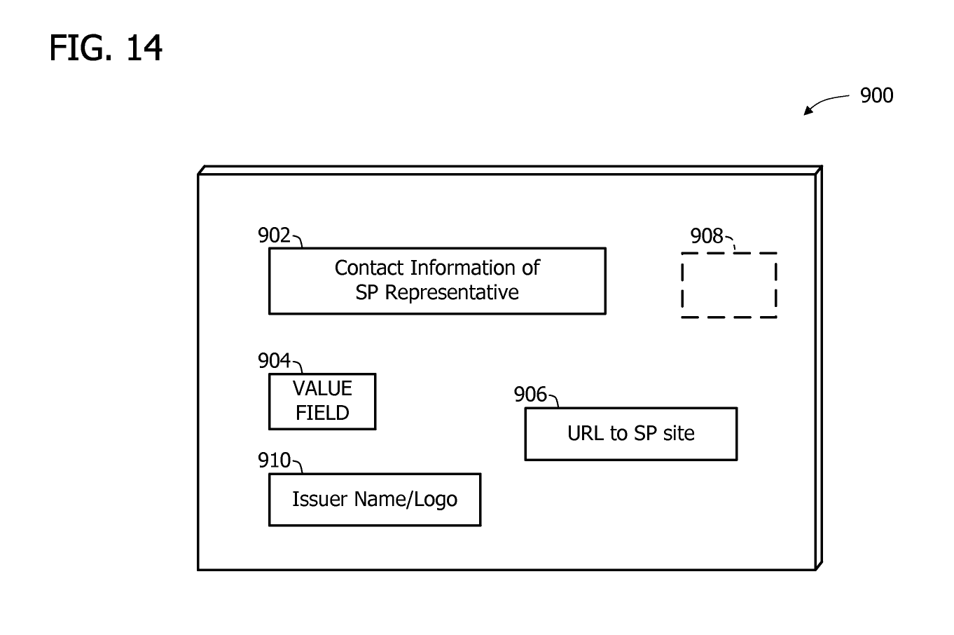

FIG. 14 illustrates an example enhanced business card 900. Business card 900 includes a field 902 that includes contact information for the SP representative, such as the SP representative's name, business address, email address, and telephone number(s). Business card 900 may include a value field 904 that may be a preprinted value or amount, providing a reminder to the SP representative of the value or amount to be transferred to card 900. Alternatively, field 904 may be a blank field that allows the SP representative to physically write a value or amount onto the card at the time of transfer. In addition, the SP may include a web address or a quick read bar code 906 on the enhanced business card such that the developer can enter the web address into a computer or may scan the bar code with a smartphone and be automatically directed to a website or portal designated by the SP. Card 900 may also include an embedded chip 908, for example, for enabling communication between card 900 and a merchant's contactless card reader. Card 900 further may include a logo or trademark 910 further identifying the SP, or another party.

In an alternative embodiment, a physical transaction card is not used. Instead, a virtual business card (“vCard”) is provided to the recipient, for saving in a digital wallet. In such an embodiment, the SP representative obtains the contact information from the developer, and saves the developer contact information using service application 418. The SP representative provides information necessary for the developer to create a digital wallet (if the developer lacks one), for example by sending an email to the developer with a link to a website where the developer can obtain any necessary information, files or applications. Included in the email may be a code or other identifier associated to the developer, to enable the developer to access the value of the virtual business card. If the developer has a digital wallet, the SP representative emails a vCard to the developer that contains as an attachment a file representing a value that the developer can use in an electronic commercial transaction.

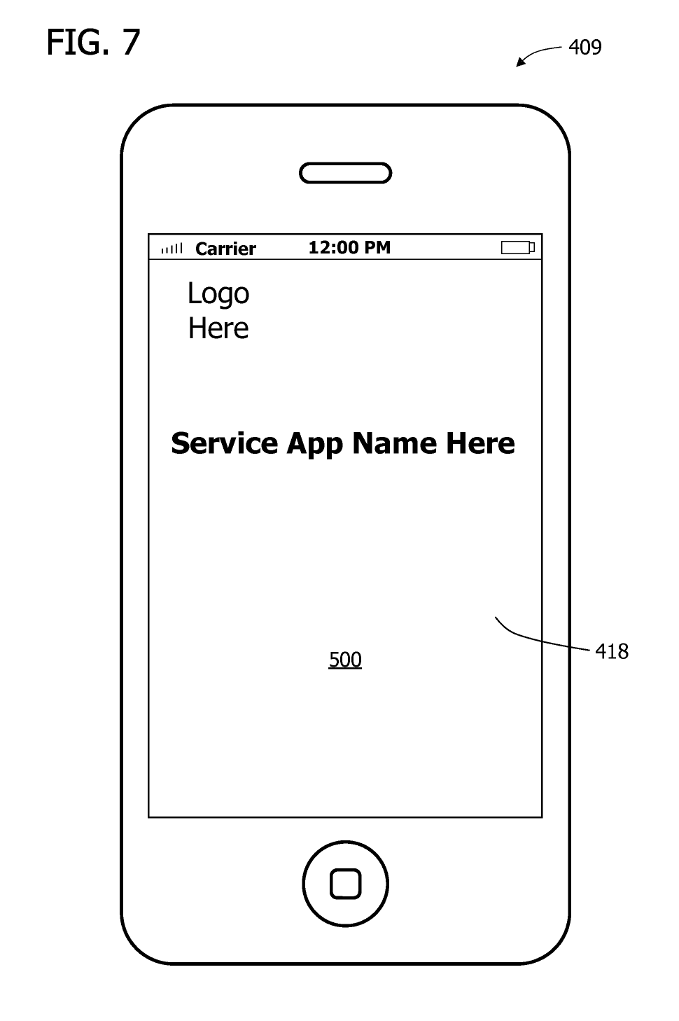

FIGS. 7-11 are illustrations representing screenshots of an example implementation of a service application, such as P2P application 418 on a portable computing device, such as smartphone 409, used in SP processing system 400 as shown in FIGS. 5 and 6. In the example embodiment, P2P application 418 is MasterCard's®0 P2P MoneySend™ service application; however, any other suitable application could be substituted for MasterCard's® P2P MoneySend™ service application. As previously discussed with respect to FIGS. 5 and 6, a service application is stored on SP computer device 416 or on an SP representative's portable computing device 409 (as shown in FIG. 7). P2P application 418 receives data, such as the enhanced business card recipient's information or a value transfer request that is inputted by an SP representative. P2P application 418 communicates the recipient's information to the appropriate party, which is at least one of the SP and the issuer bank. P2P application 418 may also receive data sent to it from other parties either by an Internet connection or via API platform 412.

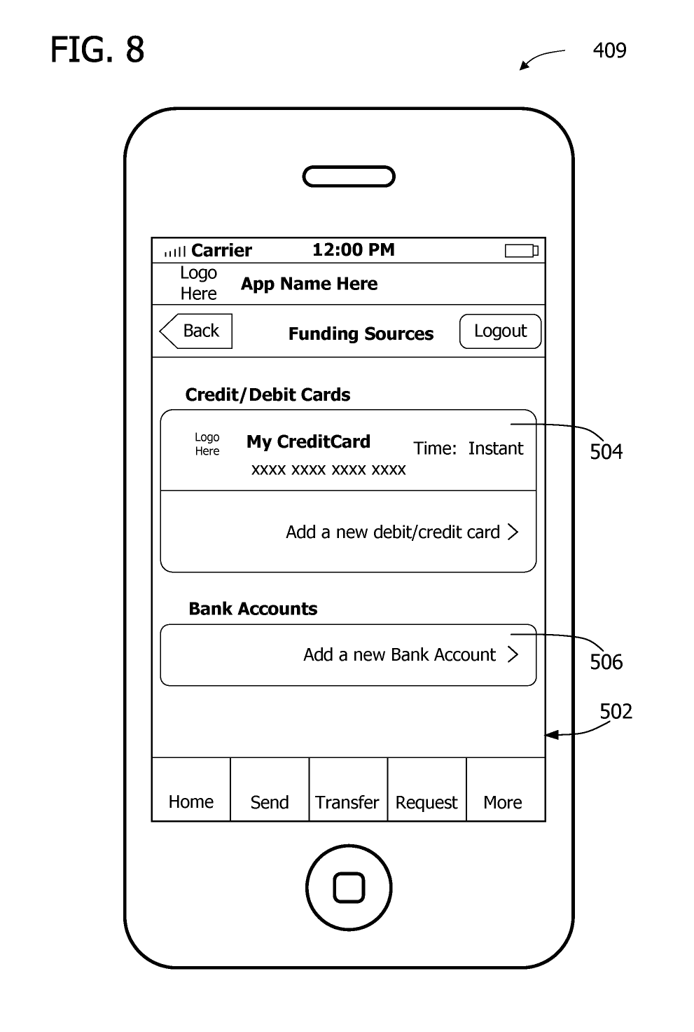

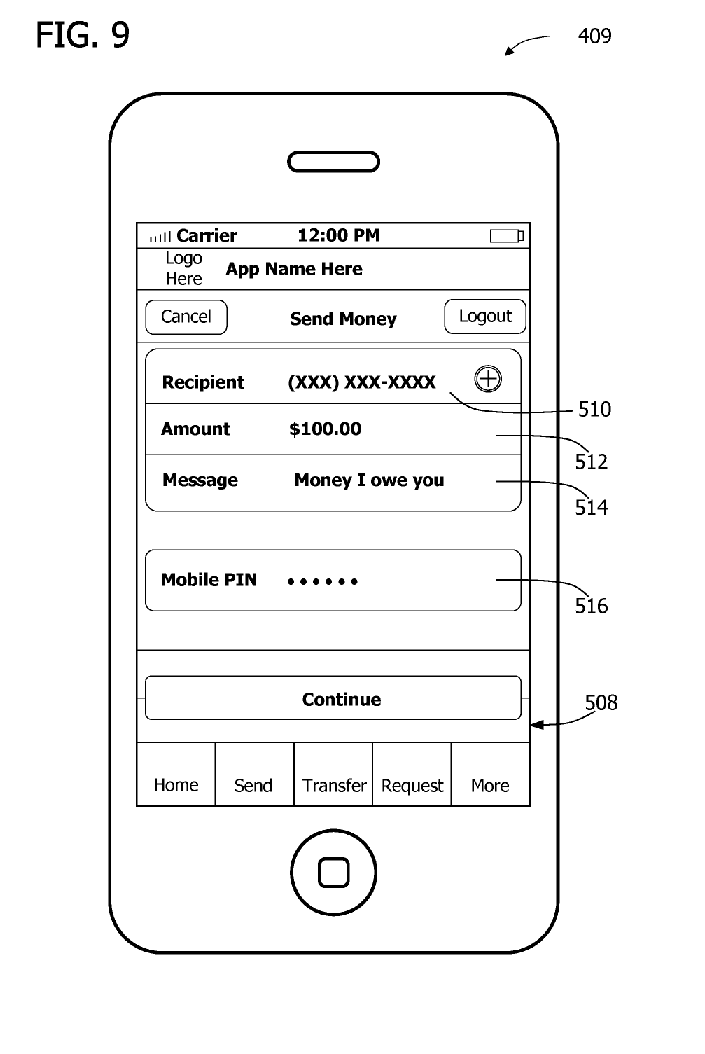

FIG. 7 shows the start-up screen 500 for service application 418 being implemented on a portable computing device (such as user's smartphone) 409. FIG. 8 displays on smartphone 409 a funding sources screen 502 that indicates available funding sources 504, 506 from which the user may receive transfers of value or money. In the example embodiment, the sources are organized by the service application by the types of the available accounts, such as credit/debit cards 504 and bank accounts 506. FIG. 9 displays on smartphone 409 a send money screen 508. A send money function of the service application allows the user to transfer value or money to a recipient's account, such as in the example embodiment, in which an SP representative using a portable computing device 409 (shown in FIG. 5) transfers value to the enhanced business card. The user either enters a recipient's name or other contact information 510 or selects one stored within the smartphone's memory. Next, the user inputs the amount 512 of value or money to be transferred. The user may also include a brief message 514 to indicate the purpose or subject of the transfer to the recipient. Finally, the user must enter a preset PIN number 516 to verify the transfer as a security measure before the transfer request is sent.

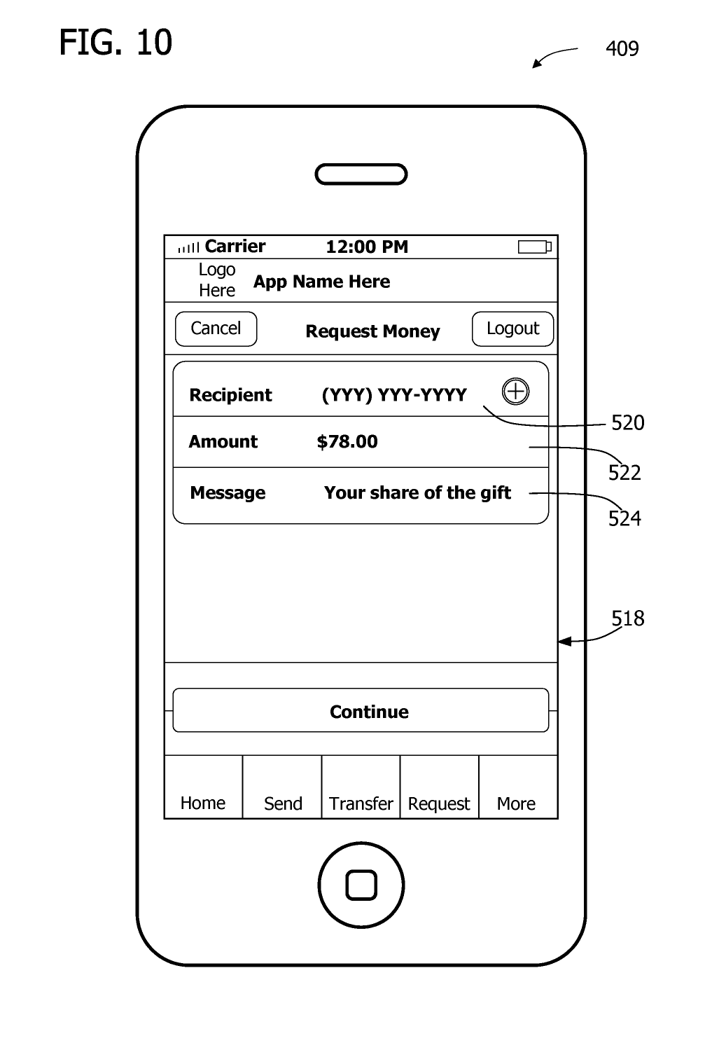

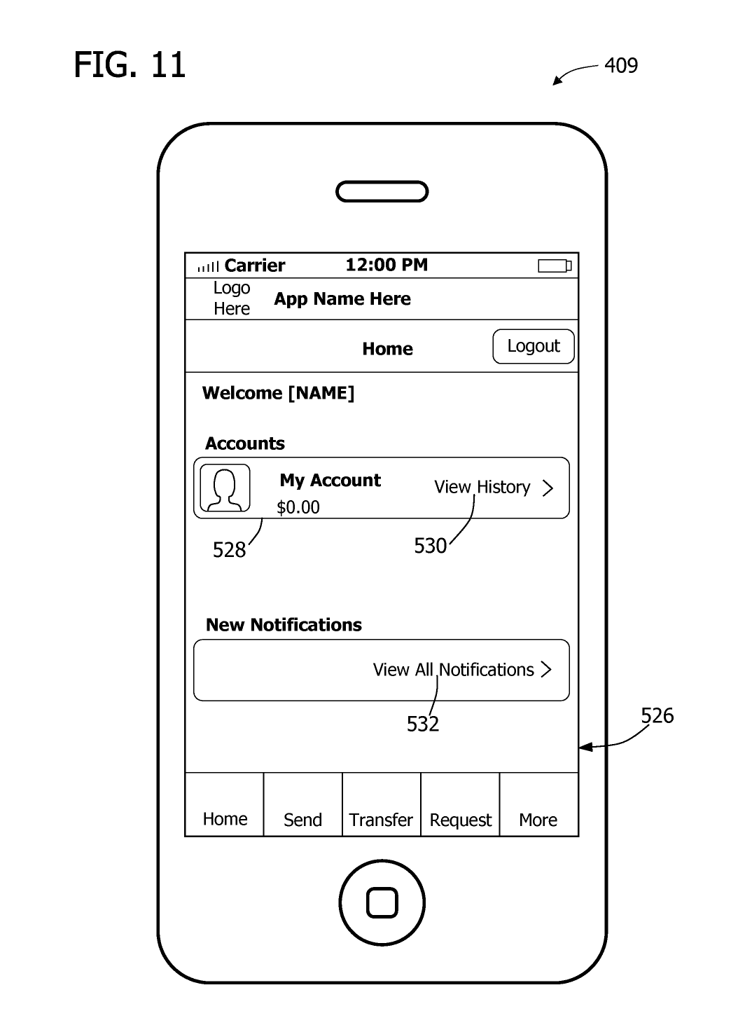

FIG. 10 displays on smartphone 409 a function that allows the user to request value or money from a person or company. Using a request money screen 518, to request funds, the user inputs the recipient's phone number (or name or other identifier) 520, an amount to be requested 522, and a message 524 in the same manner as described with respect to FIG. 9. The service application then communicates the request to the owing party. FIG. 11 illustrates a user's home screen 526, as displayed on smartphone 409. The home screen displays the user's account summaries, such as account balances 528, transaction histories 530, and notifications 532. The screenshots illustrated in FIGS. 7-11 are intended as examples only, and the present disclosure is not limited thereto, as other screen configurations may be developed by those of ordinary skill having the present disclosure before them, without departing from the scope of the present invention.

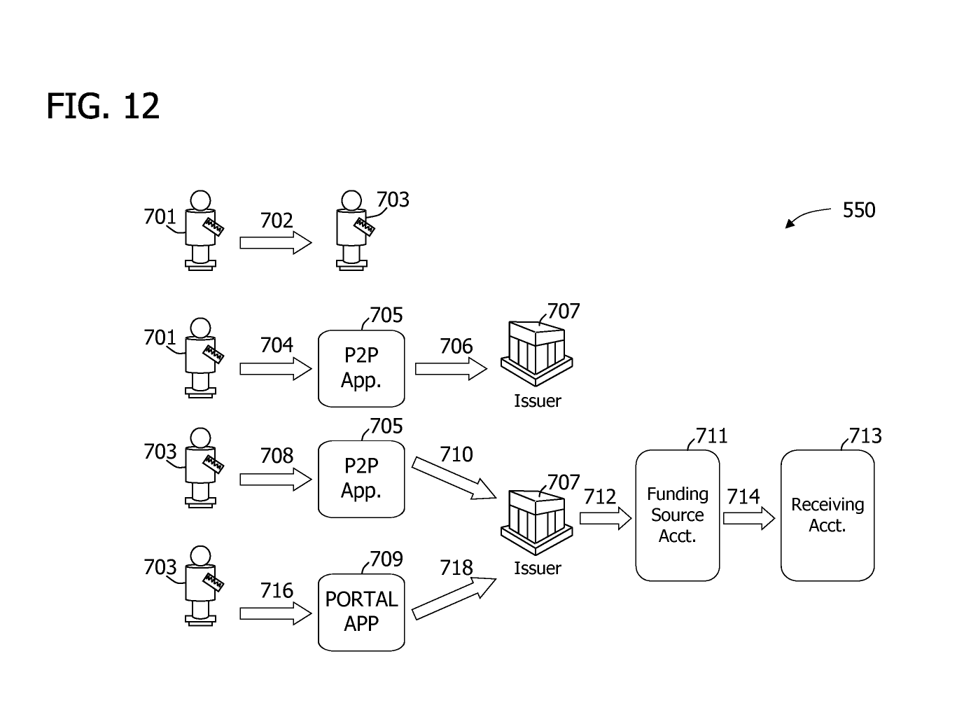

FIG. 12 is a data flow diagram 550 that shows the data transfers relating to P2P service application 418 and API platform 412 (both shown in FIG. 5). P2P application 418 and API platform 412 support the example configuration of SP processing system 400 (shown in FIG. 5) by providing the logic needed to allow the various parties to request value transfers between the different users without having to know more than user identifiers. In operation, an SP representative 701 gives 702 an enhanced business card, which may be a pre-paid transaction card, to a developer 703. While in the presence of developer 703, SP representative 701 then personalizes the enhanced business card by inputting 704 contact data of developer 703 into a mobile phone application 705, such as P2P application 418 (shown in FIG. 5). Application 705 communicates 706 the developer's information to a user computer device 408 (shown in FIG. 5), in this case an issuer bank 707. Once issuer bank 707 confirms receipt of the information and the enhanced business card has been personalized for developer 703, SP representative 701 initiates 708 a value or money transfer to the enhanced business card using application 705 (P2P application 418 shown in FIG. 5). SP representative 701 inputs developer 703 as the recipient of the funds transfer in application 705 (as is shown in FIG. 9), via an API platform (not shown, but which may be the same as API platform 412 shown in FIG. 5). Application 705 communicates 710 (via the API platform) the request to issuer bank 707. Because issuer bank 707 already has the information of developer 703, and the information associated with the enhanced business card given to developer 703, issuer bank 707 can authorize 712 the transfer 714 of value or money from funding source account 711 of SP representative 701 to the receiving account 713 of developer 703 without requiring any further information or verification from either of the parties involved in the P2P transaction. Thus, P2P application 705 and the API platform facilitate the transfer of value or money from one account to another based only on user identifiers. Moreover, the API platform also identifies the appropriate routing of the transfer request and performs notifications. In an embodiment, funding source account 711 and receiving account 713 may be maintained by the same financial institution.

In the alternate embodiment, as shown in FIG. 12, the SP may include a web address or a quick read bar code 906 (shown in FIG. 14) on enhanced business card 900 such that the card recipient (developer 703) can enter the web address into a computer or may scan the bar code with a smartphone and be automatically directed to a website or portal 709 designated by the SP. Once at the website or portal, developer 703, using developer computer device 404 (shown in FIG. 5), signs-up or registers 716 for the SP's products or services by communicating with SP computer system 402 (shown in FIG. 5). After developer 703 registers with the SP's system, SP computer system 402 compares registration information of developer 703 to its sales management database. SP computer system 402 confirms the identity of developer 703 as being the same developer 703 whose contact details were stored at the time of personalizing the enhanced business card, SP computer system 402 (via portal 709 and the API platform) communicates 718 with issuer bank 707 to transfer additional value to the enhanced business card. Because issuer bank 707 already has information for developer 703 and the information associated with the pre-paid card that was given to developer 703, issuer bank 707 can authorize 712 the transfer 714 of the funds from funding source account 711 of SP representative 701 to receiving account 713 of developer 703, without requiring any further information or verification.

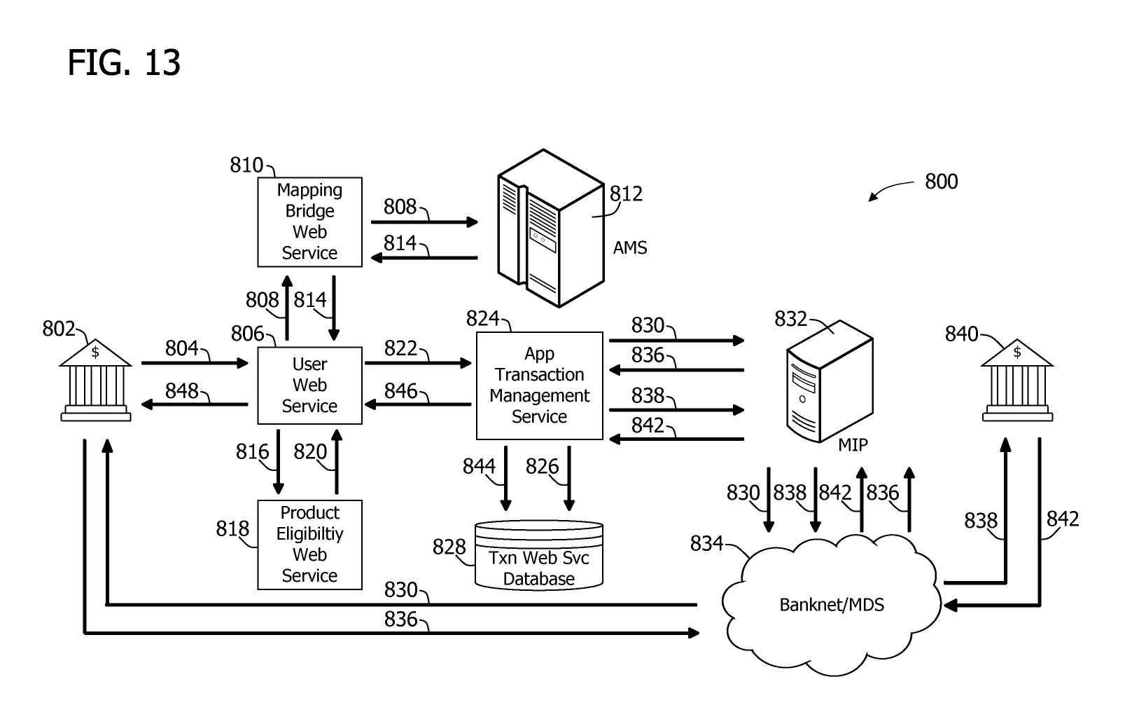

FIG. 13 is a block diagram 800 that illustrates the transfer of funds from the SP's funding source account 711 to the recipient's receiving account 713 as shown in FIG. 12. An acquirer (i.e., an SP) 802 sends 804 a money transfer request to a user web service 806. User web service 806 looks up account mapping information, by sending an information request 808 via mapping bridge web service 810 to an account management system (AMS) 812. AMS 812 returns 814 the requested account mapping information via mapping bridge web service 810 to user web service 806, which then sends 816 a card eligibility request to a product eligibility web service 818. Upon receiving a response 820 from product eligibility web service 818, user web service 806 forwards 822 the money transfer request to an application transaction management service 824. Application transaction management service 824 saves 826 the request in a transaction web service database 828 as a funding/payment request and then sends a funding request 830 using a mobile internet protocol (MIP) 832 through a network 834 such as Banknet or MasterCard® Debit Switch (MDS) to acquirer 802. Acquirer 802 returns a funding response 836 back through network 834 and MIP 832 to application transaction management service 824. Application transaction management service 824 then sends a payment request 838 through Banknet or MDS 834 to an issuer 840 of enhanced business card. Issuer 840 provides a response 842 over network 834 back to application transaction management service 824, which saves 844 the responses in its database. Application transaction management service 824 then returns 846 a money transfer response to user web service 806, which forwards 848 the response back to acquirer 802.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for processing an enhanced business card, said computer system associated with a service provider (SP), said computer system comprising:
a memory device for storing data; and
a processor, said processor in communication with said memory device, said processor programmed to:
receive identifying data identifying a recipient of the enhanced business card;
provide the received identifying data to an issuer of the enhanced business card; and
load a value provided by the SP on the enhanced business card.

2. A computer system in accordance with claim 1, wherein said business card contains contact information regarding the SP.

3. A computer system in accordance with claim 1, wherein said processor is programmed to load additional value provided by the SP when the recipient of the enhanced business card performs an action predetermined by the SP.

4. A computer system in accordance with claim 3, wherein said processor is programmed to store recipient identifying data in a database associated with the SP.

5. A computer system in accordance with claim 4, wherein said processor is programmed to:
receive recipient registration information;
compare the received recipient registration information to the stored recipient identifying data; and
confirm the identity of the recipient.

6. A computer system in accordance with claim 1, wherein the SP is one of a payment network provider and an interchange network provider.

7. A computer system in accordance with claim 1, wherein the value loaded onto the enhanced business card is one of a monetary value and a non-monetary value redeemable at a merchant.

8. A computer system in accordance with claim 1, wherein the recipient is an application developer.

9. A computer system in accordance with claim 1, wherein said processor is programmed to receive from the issuer a confirmation of receipt of recipient identifying data by the issuer.

10. A computer system in accordance with claim 1, wherein said processor is programmed to load value onto the enhanced business card by initiating a monetary transfer using a P2P application.

11. A computer-implemented method of processing an enhanced business card using a computing device coupled to a memory device, said method comprising:
receiving, at the computing device, identifying data identifying a recipient of the enhanced business card;
providing the received identifying data to an issuer of the enhanced business card; and
using the computing device to load a value provided by a service provider (SP) on the enhanced business card.

12. A method in accordance with claim 11, said method further comprising incorporating into the business card contact information regarding the SP.

13. A method in accordance with claim 11, said method further comprising loading additional value provided by the SP when the recipient of the enhanced business card performs an action predetermined by the SP.

14. A method in accordance with claim 13, said method further comprising storing recipient identifying data in a database associated with the SP.

15. A method in accordance with claim 14, said method further comprising:
receiving recipient registration information;
comparing the received recipient registration information to the stored recipient identifying data; and
confirming the identity of the recipient.

16. A method in accordance with claim 11, wherein the SP is one of a payment network provider and an interchange network provider.

17. A method in accordance with claim 11, wherein the value loaded onto the enhanced business card is one of a monetary value and a non-monetary value redeemable at a merchant.

18. A method in accordance with claim 11, wherein the recipient is an application developer.

19. A method in accordance with claim 11, said method comprising receiving from the issuer a confirmation of receipt of recipient identifying data by the issuer.

20. A method in accordance computer system in accordance with claim 11, wherein said processor is programmed to load value onto the enhanced business card by initiating a monetary transfer using a P2P application.

21. One or more computer-readable storage media having computer-executable instructions embodied thereon for processing an enhanced business card, wherein the computing device includes a memory device and a processor associated with a service provider (SP), wherein when executed by said processor, the computer-executable instructions cause said processor to:
receive identifying data identifying a recipient of the enhanced business card;
provide the received identifying data to an issuer of the enhanced business card; and
load a value provided by the SP on the enhanced business card.

22. The computer-readable storage media in accordance with claim 21, wherein the business card contains contact information regarding the SP.

23. The computer-readable storage media in accordance with claim 21, wherein said computer-executable instructions cause said processor to load additional value provided by the SP when the recipient of the enhanced business card performs an action predetermined by the SP.

24. The computer-readable storage media in accordance with claim 21, wherein said computer-executable instructions cause said processor to store recipient identifying data in a database associated with the SP.

25. The computer-readable storage media in accordance with claim 24, wherein said computer-executable instructions cause said processor to:
receive recipient registration information;
compare the received recipient registration information to the stored recipient identifying data; and
confirm the identity of the recipient.

26. The computer-readable storage media in accordance with claim 21, wherein the SP is one of a payment network provider and an interchange network provider.

27. The computer-readable storage media in accordance with claim 21, wherein the value loaded onto the enhanced business card is one of a monetary value and a non-monetary value redeemable at a merchant.

28. The computer-readable storage media in accordance with claim 21, wherein the recipient is an application developer.

29. The computer-readable storage media in accordance with claim 21, wherein the computer-executable instructions cause said processor to receive from the issuer a confirmation of receipt of recipient identifying data by the issuer.

30. The computer-readable storage media in accordance with claim 21, wherein the computer-executable instructions cause said processor to load value onto the enhanced business card by initiating a monetary transfer using a P2P application.
